(19) United States
(12) Patent Application Publication
(10) Pub. No.: US 2004/0024135 A1
(43) Pub. Date: Feb. 5, 2004

(54) Use of a polymer based on imidized maleic anhydride in surface treatment or coating compositions and in inks and varnishes

(76) Inventors: Christophe Verge, Coye la Foret (FR); Baudouin Duque, Mouy (FR); Christophe Dumousseaux, Shinjuku-ku (JP)

Correspondence Address: COZEN AND O'CONNOR, 1900 MARKET STREET, PHILADELPHIA, PA, 19103, US

(21) Appl. No.: 10/236,599

(22) Filed: Sep. 6, 2002

Related U.S. Application Data
(63) Continuation of application No. PCT/FR01/00702, filed on Mar. 8, 2001.

(30) Foreign Application Priority Data
Mar. 9, 2000 (FR) 00/03031

(51) Int. Cl. C08F 8/30

(52) U.S. Cl. 525/327.6

(57) ABSTRACT

Substrates having a water-soluble substance subject to migration toward the surface of the substrate are treated or coated with a composition comprising a a latex or solution of a film forming polymer and sufficient imidized maleic anhydride polymer dispersant or emulsifier to inhibit the migration toward the surface of the water-soluble substance. Preferably a styrene-maleic anhydride polymer is imidized with a diamine and is made cationic by neutralizing with an acid. The imidized polymer is preferably the only surfactant or dispersant in the latex composition. Pigment pastes and primers comprising the imidized polymer can be applied to substrates to confer water and alkaline hydrolysis resistance and to prevent the migration of any water soluble substance in the substrate.

### BACKGROUND OF THE INVENTION

1. Field of the Invention

The present invention relates to compositions and methods for the surface treatment or coating of substrates. In particular, the invention relates to treatment of substrates to prevent migration to the surface of the substrate of water soluble substances, to confer resistance to water, and resistance to alkaline hydrolysis on the coating.

2. Description of the Prior Art

Compositions used for the surface treatment of materials such as metals, paper, glass, wood or building materials can be aqueous or based on organic solvents.

Aqueous surface treatment formulations have practical and ecological advantages over organic formulations, but prior aqueous formulations have not adequately prevented migration of water-soluble coloring substances to the surface of the substrates. On contact with an aqueous formulation, any water-soluble substances in the substrate dissolve and rise to the surface.

The application of a solvent system resolves the various problems; with a system comprising water, the formulator has to select all the constituents (the binder(s), the pigmentation, the additives and the solvents) from the perspective of optimizing the isolating capability of the coating. However, there are certain disadvantages to solvent systems such as the ease of application, the open time, the appearance, the gloss, or the adhesion.

Some species of wood, in particular tropical species, are rich in water-soluble coloring substances known as tannins. When these untreated woods are coated with an aqueous system, such as a latex paint, the tannins are extracted from the substrate and migrate to the surface, which they color in an unsightly way. The coloring is apparent through the successive layers unless an isolating layer blocks the ascent of the coloring substance. Some coloring substances, soluble in water at basic pH, have an anionic nature. One strategy for immobilizing them has been to render them insoluble by precipitation on insoluble cationic resins.

U.S. Pat. No. 3,494,878 discloses blocking tannins and flash rusting by the combination of a film-forming latex and of an insoluble cationic or anionic resin.

PCT publication WO 94/29393 discloses the blocking properties of a non-film-forming cationic resin used in combination with a compatible film-forming aqueous dispersion to formulate an aqueous correction fluid.

European patent application EP-A-322,188 also discloses improving resistance to water and blocking tannins by incorporation of anionic surfactants in an aqueous dispersion of a non-film-forming and insoluble polymer functionalized by a weak base. It is noteworthy that the weakly basic resin loses its blocking effectiveness when it is film-forming according to U.S. Pat. No. 3,494,878, which discloses that some types of tannins escape the blocking capability of the cationic resin, which an anionic resin would be more efficient in immobilizing.

A combination of cationic and anionic functionalities offers a broader range of blocking effectiveness as disclosed by European patent application EP-A-837 110, wherein a cationic ion-exchange resin, e.g., a divinylbenzene-styrene copolymer carrying a quaternary ammonium, combined, as in U.S. Pat. No. 3,494,878, with a polymer in emulsion, is activated by a water-soluble anionic polymer.

U.S. Pat. No. 5,141,784 discloses a treatment of a wood rich in tannins by application of enough carboxylic acid salt and/or of a water-soluble polymer functionalized by quaternizable amino groups and with a molecular weight of 50 to 300,000.

U.S. Pat. No. 5,051,283 discloses an aqueous coating which comprises an alkaline salt of a mono- or di-carboxylic acid and a water-soluble polymer carrying quaternizable amino groups and with a molecular weight of 50 to 300,000.

U.S. Pat. No. 4,075,394 discloses the treatment of a wood rich in tannins with a polyaziridine.

It is known that functionalization of dispersions of addition polymers based on vinyl or ethylenically unsaturated monomers with amino monomers, which are optionally quaternized for coating. European patent application EP-A-290 777 and U.S. Pat. No. 4,760,110 disclose the production of amphoteric latices by a two-stage process.

United States patent U.S. Pat. No. 3,404,114 disclosed a sequential process for introducing an aminoacrylate, e.g., t-butylaminoethyl methacrylate (TBAEMA), into a functionalized latex by introduction in the second stage after neutralization to produce a stable latex.

European patent application EP-A-587 333 discloses a latex which comprises an insoluble polymer functionalized with tertiary amine grafted to a water-soluble polymer functionalized with acid wherein the latex is stable and is formulated as a semitransparent stain which is resistant to water and which exhibits a good open time. The blocking of water-soluble substances, however, is not claimed in said European patent application.

The presence of amino functional groups does not, ipso facto, confer effectiveness in blocking tannins and other blemishes because the formulation plays a determining role, specifically the formulation pH, the choice of neutralizing agent, the presence of zinc oxide, of zirconium salts, or of zinc salts contribute to the formation of effective complexes. According to European patent application EP-A-407 085, it is possible to block tannins equivalent to that of an alkyd primer in the solvent phase by formulating a functionalized latex which is cationic at acidic to neutral pH with an aminosilane dispersant.

European patent application EP-A-622,427 and U.S. Pat. No. 5,527,619 disclose a combination of an acid-functionalized polymer with an aminosilane which confers excellent properties of blocking tannins and various blemishes.

European patent application EP-A-192,077 discloses the formulation of a primer based on a dispersion comprising a water-soluble polymer amine-zinc complex. The primer in question effectively blocks wood tannins.

United States patent U.S. Pat. No. 5,681,880 discloses replacement of aforementioned zinc complexes by water-soluble zirconium complexes.

The same problem of migration is posed in the renovation of walls contaminated by a yellowish deposit left by cigarette smoke (nicotine), by the soot which migrates through the wall of the chimney or by the damp patches resulting from a water leakage or an absence of imperviousness of the building.

When an aqueous system is applied to untreated steel, rust stains appear virtually instantaneously at the surface. The phenomenon is known as flash rusting.

The prior state of the art relating to resistance to alkaline hydrolysis may be described as follows:

International application PCT WO-98/02491 discloses the synthesis of a polymer dispersion in the presence of a polyester seed which results in films exhibiting good resistance to alkaline hydrolysis but mediocre resistance to water.

International application PCT WO-95/01228 claims the use of a fatty alcohol (meth)acrylic ester which makes it possible to enhance the resistance to hydrolysis in an alkaline medium of dispersions synthesized on the basis of styrene-acrylic acid copolymers, the difficulty with such a system being that of optimizing the resistance to alkalis, the stability of the latex, and the like.

European patent application EP-A-478,193 discloses the synthesis and the use of a core-shell latex exhibiting a core which is insoluble in acidic medium and a quaternizable shell based on the use of dimethylaminoethyl methacrylate (DMAEMA), such that the core and shell are bonded chemically by use of a multifunctional monomer.

EP 0644205 Al discloses a process for producing a latex with a very fine particle size (less than 100 nm and preferably of between 5 and 40 nm), exhibiting rather low solid levels of the order of 25%, and its use in various fields related to coatings (wood preservation, water-repellent finishing product, product for the paper industry, and the like). Said patent is based essentially on the fine size of the particles of the latices, the applicative part being essentially exemplified in terms of penetration into wood and of textile treatment.

The painting of a new building or a building to be restored often requires the application of a base coat or of a primer which makes possible the attachment of the paint to the support, the requirements being different according to the circumstances, as, in the case of a renovation, the faces are crumbly and chalking, in contrast to a recent construction, where the supports are healthy.

Buildings are furthermore composed of supports of highly varied natures, such as cement, concrete, plaster or wood, and therefore require “universal or multibase” solvent- or aqueous-phase base coats.

The products used in this field are still mainly solvent-based, as is the case with Impriderme, which constitutes a problem in terms of emission of volatile organic compounds and in terms of smell. Other aqueous-phase products exhibiting extremely fine particle sizes are now proposed, but these products have the disadvantage of exhibiting only very low concentrations.

The Rhodopas Ultrafine products, such as Ultrafine PR 3500, manufactured and sold by Rhodia, have advantages in terms of particle size, of penetration and of rheology. For this reason, they are applied in the fields of the consolidation of chalking faces or of the blocking of the penetration of salts.

To our knowledge, the patent literature and the technical reviews relating to the formulations of isolating coatings do not disclose a technology which employs these polymers based on imidized maleic anhydride, such as imidized styrene-maleic anhydride (iSMA) copolymers:

U.S. Pat. No. 3,444,151 discloses the synthesis of iSMAs and their use in emulsion polymerization for the purpose of latex synthesis, is known. In this known emulsion polymerization, the iSMA is used in a proportion of 2 to 20% by weight with respect to the monomers, which is in fact insufficient for the production of latices which are correctly stabilized in the absence of a conventional surface-active agent; the examples of U.S. Pat. No. 3,444,151 are all based on the joint use of a conventional surfactant and the applications of the aqueous dispersions obtained in the presence of iSMA are only mentioned in a general way in this United States patent; and the use of latices synthesized on an iSMA base in a field other than those of the present invention, namely in the sizing of paper, is also known from the French patent application filed under No. 99/07910.

### SUMMARY OF THE INVENTION

The invention relates to the field of the surface treatment of various materials, e.g., wood, metals, paper, glass, building materials, textile and leather, and to ink and varnish compositions, in particular to the surface treatment of wood and steel and more particularly to the isolating and protective coating which prevents the migration of water-soluble compounds present at the surface and within the material toward the surface of the coating.

The present invention also relates to another important aspect in the fields of coatings in general and in the field of painting in particular but also in other fields, such as those of inks and varnishes, leather or even textiles, namely the achievement of maximum resistance to alkaline hydrolysis, in order to limit the deterioration in the coating under the action of alkaline cleaning solutions, for example, or under the action of an alkaline substrate, such as concrete, for example.

The present invention also relates to the field of the treatment of surfaces, particularly to the reinforcing treatment of surfaces of porous substrates.

We have discovered that the migration of water-soluble substances can be prevented in a much simpler way than in the prior state of the art and with success by a surface treatment or a coating formulated with a polymer based on imidized maleic anhydride. The imidized polymer can also be formulated in combination with an aqueous polymer dispersion or with an aqueous dispersion based on olefinic or vinyl monomers polymerized under radical conditions in its presence, the imidized polymer acting as polymer surfactant, and/or of a combination of the two, it being possible for said imidized polymer advantageously to be used as dispersant at acidic pH of pigments, when the presence of the latter is envisaged or necessary. A good isolating capability is then obtained without employing specific additives and active pigments, and the applicative properties are satisfactory.

We have discovered that the aqueous dispersions based on olefinic or vinyl monomers polymerized under radical conditions in the presence of said imidized polymer acting as polymer surfactant, which are used alone or in formulation, result in coatings resistant to alkaline hydrolysis which can be used in the field of paint (in particular coatings for concrete), inks and varnishes, textiles and leather, as will also be expanded upon below.

A first subject matter of the present invention is therefore the use, in compositions for the surface treatment or coating of substrates and in ink and varnish compositions, of at least one polymer based on imidized maleic anhydride as agent which inhibits the migration toward the surface of water-soluble substances present in and on the substrate and/or which confers resistance to water and to alkaline hydrolysis on the coating.

In accordance with a first embodiment of the present invention, the polymer based on imidized maleic anhydride is applied after having been placed in aqueous solution and then neutralized with an acid in order to give a cationic polymer, said acid being a volatile weak acid, such as, for example, acetic acid or formic acid.

The aqueous solution of said cationic polymer can be applied as such, in particular as primer; it can also be applied in combination with at least one other constituent compatible with said cationic polymer. This or these other constituents can be chosen from latices, aqueous film-forming dispersions, pigments, cosolvents and the other normal additives of compositions for the surface treatment and coating of substrates, the copolymer based on imidized maleic anhydride also participating as dispersant in the preparation of these compositions. The term “compatibility” is understood to mean that the mixture is stable (no flocculation).

In particular, the aqueous solution of the cationic copolymer can be formulated in combination with an acrylic, vinyl or styrene-acrylic film-forming dispersion in order to form in particular a primer. It can also participate as dispersant in the preparation of pigment pastes in an acidic medium, it being possible for said pigment paste in particular to be incorporated in a paint or varnish composition.

In accordance with a second embodiment of the present invention, the copolymer based on imidized maleic anhydride is applied after having been used as polymer surfactant in the preparation of a latex, in particular as sole polymer surfactant.

The latex, in the preparation of which the polymer based on imidized maleic anhydride has been used as surfactant, can be applied as such or can be applied in combination with at least one other constituent compatible with said latex (the “compatibility” was defined above). This or these other constituents can be chosen from other latices, pigments, cosolvents and the other normal additives of compositions for the surface treatment and coating of substrates.

In particular, the resulting composition can be a paint composition, the latex, in the preparation of which the polymer based on imidized maleic anhydride has been used as surfactant, being incorporated as sole binder or as one of the binders in said paint or varnish composition. A pigment paste, prepared in an acidic medium with an aqueous cationic polymer solution as defined according to the invention, can advantageously be incorporated in said paint or varnish composition.

The polymer based on imidized maleic anhydride employed according to the present invention is a polymer which has been obtained by reaction of a diamine and of a polymer based on maleic anhydride, the diamine having in particular reacted completely with the anhydride functional group with a molar ratio of 1 to 1, said polymer having in particular a number- average molecular mass of 500 to 20 000, in particular of 2 000 to 5 000. This molar ratio of 1 to 1 should not, however, be regarded as limiting.

The synthesis of the polymers based on imidized maleic anhydride used according to the present invention is by reaction between the base polymer and a primary tertiary diamine, for example dimethylpropylenediamine (DMAPA), preferably by a bulk process. The primary amine functional group reacts with the anhydride functional group to form an amic acid and then the ring recloses to form the imide derivative.

The imidized polymers of use according to the present invention are preferably those in which the diamine reacts with the anhydride functional group with a molar ratio of preferably about 1 to 1. Imidized polymers exhibiting residual anhydride or acid functional groups are suitable but less preferred.

The polymer based on maleic anhydride according to the invention is advantageously a copolymer or terpolymer composed of maleic anhydride and of hydrophobic monomers chosen from ?-olefins, unsaturated ethylenic aromatic monomers, vinyl ethers and allyl ethers. A preferred polymer based on maleic anhydride is a copolymer based on styrene and on maleic anhydride with a styrene/maleic anhydride molar ratio of 1/1 to 6/1, in particular of 2/1 to 4/1; and with in particular an acid number of 500 to 200 KOH/g. Examples are the copolymers sold by “Atofina” under the names SMA 1000, SMA 2000, SMA 3000, SMA EF30, SMA EF40 and SMA EF60.

The present invention is also relates to a primer for the surface treatment of a substrate consisting of or comprising an aqueous solution of a polymer based on imidized maleic anhydride as defined above, said polymer having been neutralized with an acid in order to exhibit a cationic nature.

The aqueous solution can exhibit a solids content of 10 to 40% by weight.

The invention also relates to a composition for the surface treatment or coating of a substrate, characterized in that it consists of or in that it comprises an aqueous solution of a polymer based on imidized maleic anhydride as defined above, said polymer having been neutralized with an acid in order to exhibit a cationic nature, in combination with at least one other constituent chosen from latices, pigments, cosolvents and the normal additives, said aqueous solution also acting as dispersant.

The invention also relates to a pigment paste comprising, as dispersant at an acidic pH, an aqueous solution of a polymer based on imidized maleic anhydride as defined above, said polymer having been neutralized with an acid in order to exhibit a cationic nature.

In particular, the pigment paste can consist, per 100 parts by weight, of 20 to 90 parts by weight of pigments; 10 to 80 parts by weight of water; 0.5 to 5 parts by weight of an acid; and 0.05 to 50 parts by weight of the aqueous solution as defined above.

The invention also relates to a composition for the surface treatment or coating of a substrate, characterized in that it consists of or that it comprises a latex which has been synthesized by emulsion polymerization of monomers possessing ethylenic unsaturation in an aqueous solution comprising more than 20% by weight, in particular more than 20% to 30% by weight, with respect to the monomers of the polymer based on imidized maleic anhydride as defined above, said polymer having been neutralized with an acid in order to exhibit a cationic nature, said cationic imidized polymer being used as surface-active agent, in particular as surface-active agent, in the presence of a conventional radical initiating system.

The invention thus relates mainly to the use of imidized SMA in the surface treatment of various materials and in the formulation of an aqueous coating, in combination, if appropriate, with a latex synthe-sized in a conventional fashion or in the presence of imidized SMA and, if necessary, depending on the nature of the desired coating (pigmented or transparent coating), with various additives used conventionally in the formulation of paints and varnishes, including in particular the active pigments or additives generally used to reinforce the targeted protective and isolating effect.

### DETAILED DESCRIPTION

The radical initiator may be a water-soluble initiator, such as ammonium persulfate, potassium persulfate or sodium persulfate, optionally in combination with a reducing agent of sodium metabisulfite type, or alternatively a hydrogen peroxide or a hydroperoxide, such as tert-butyl hydroperoxide, in combination with a reducing agent, such as ascorbic acid or sodium formaldehyde sulfoxylate. This initiator may also be soluble in organic solvents, such as azo derivatives, for example azobisisobutyronitrile, or organic peroxides.

The polymerization temperature is between 30° C. and 100° C., preferably between 60° C. and 90° C., and is appropriate to the initiating system used.

The monomers are chosen in particular so as to obtain the desired glass transition temperature (Tg) but also the desired polarity, the desired functionality or the desired degree of crosslinking. This Tg can be between −25° C. and 100° C., preferably between 0° C. and 50° C.

The monomers are generally chosen from (meth)acrylic esters, such as alkyl (meth)acrylates of formula:

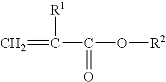

in which R¹ represents H or —CH₃; and R² represents a C₁-C₂₂ hydrocarbonaceous group or a —(CH₂)ₙ—C_{n′},F_{2n′} group with n=1 to 4 and n′=1 to 14; vinyl acetate; styrene; versatic esters; (meth)acrylic acid; acrylamide; ethylene glycol dimethacrylate. Mention may be made, as examples of (meth)acrylates, of: methyl acrylate, ethyl acrylate, 2-ethylhexyl acrylate or methyl methacrylate.

The latex of the invention has in particular a solids content of 20 to 50%, preferably of 40 to 50%, and a particle size of between 50 and 300 nm, with an average particle size preferably of less than 100 nm.

The composition can also comprise at least one other constituent chosen from other latices, dispersants, for example an aqueous solution as defined above, a pigment paste, for example as defined above, cosolvents and the normal additives.

In addition, it should be noted that imidized SMA has proved to be an excellent dispersant of pigments in an acidic medium, resulting in pigment pastes exhibiting good stability and low viscosity, which can therefore be incorporated, in particular, in paint formulations at acidic pH, characterized by an improved isolating capability and an improved resistance to water.

Depending on its composition and its formulation, the coating is suitable for the covering of inorganic substrates (masonry, walls to be renovated, and the like), organic substrates (wood, paper, leather, and the like) and metal substrates and is characterized by the ability to block the ascent of water-soluble entities, in particular those, such as nicotine, wood tannins or metal salts, which lead to coloring of the surface of the film.

When applied to metal, the coating according to the invention does not give rise to the phenomenon of flash rusting and makes it possible to obtain protection against corrosion superior to that achievable with a formulation based on a conventional latex.

According to a preferred process, the imidized SMA can finally be used for the purpose of the synthesis of an aqueous dispersion of acrylic, vinyl or styrene-acrylic polymer in the absence of any conventional surfactant; which makes it possible to also obtain a cationic latex resulting in a coating exhibiting good film-forming properties, a good isolating capability, good resistance to alkaline hydrolysis, in comparison in particular with a latex obtained on an SMA base, and resistance to water which is further improved because of the absence of conventional surfactant.

This latex can very obviously be formulated and can in particular be combined with the imidized SMA used in that case as pigment dispersant of the formulation, to result in an excellent compromise in properties.

The imidized SMA, according to the various forms of the invention, is characterized by a good isolating and protective capability, good resistance to water and good resistance to alkaline hydrolysis, without it being necessary to resort to specific active con- stituents, although it is possible to reinforce these effects by the addition of the latter.

### EXAMPLES

The following examples illustrate the present invention without, however, limiting the scope thereof. In these examples, the percentages are by weight, unless otherwise indicated, and the following abbreviations were used:

| | |
|---|---|
| SMA copolymer: | styrene/maleic anhydride |
| | copolymer |
| iSMA copolymer: | imidized styrene/maleic |
| | anhydride copolymer |
| DMAPA: | dimethylaminopropylamine |
| Sty: | styrene |
| MA: | maleic anhydride |
| [Mw]: | weight-average molecular mass |

### Examples 1 to 4

Synthesis of the iSMA Copolymers Nos. 1 to 4 from the SMA Copolymers Nos. 1 to 4 Respectively

The starting SMA copolymers Nos. 1 to 4 are those available commercially from “Atofina” under the names SMA EF40, SMA 1000, SMA 2000 and SMA 3000 respectively.

The characteristics of the starting SMA copolymers No. 1 to No. 4 are quoted in table 1 below.

General Procedure

The DMAPA and then the SMA copolymer are first of all introduced at ambient temperature, in the amounts shown in table 1, into an electrically heated two liter reactor equipped with a stirring device suitable for viscous media. The reaction mixture is then heated to 150° C. before starting the stirring and then it is brought to 200° C. From this point, the reaction mixture is held under stationary reaction conditions for 75 minutes, before extrusion of the ISMA via the bottom valve of the reactor into a bath of liquid nitrogen.

The iSMA obtained is subsequently milled. Powdered iSMA copolymers Nos. 1 to 4 respectively are thus obtained, the characteristics of which are also quoted in table 1.

TABLE 1

| Example | 1 | 2 | 3 | 4 |
|---|---|---|---|---|
| Characteristics of the | | | | |
| starting SMA | | | | |
| % by mass Sty | 79.8 | 56.5 | 67.9 | 76.1 |
| % by mass of MA | 20.2 | 48.5 | 32.1 | 23.9 |
| | [symbol] 3 000 | [symbol] 3 000 | [symbol] 3 000 | [symbol] 3 000 |
| Amount of SMA (g) | 830 | 690 | 760 | 800 |
| Amount of DMAPA (g) | 170 | 310 | 240 | 200 |
| Characteristics of the | | | | |
| IsmA obtained | | | | |
| Acid number (mg KOH/g) | 7.5 | 7 | 2.6 | 10.6 |
| Level of residual DMAPA | 600 | 600 | 600 | 6 000 |
| (ppm) | | | | |
| Tg (° C.) | 112 | 82 | 82 | 91 |

### Example 5

### Dissolution of the Imidized iSMA Copolymer No. 1

171 g of the ISMA No. 1, 644 g of water and 39 g of glacial acetic acid are introduced into a three-necked glass reactor with a capacity of one liter equipped with a central stirrer, a condenser, a temperature probe and a device for introducing acetic acid. The combined reactants are heated to 60° C. and are kept stirred until the oligomer has completely dissolved.

The aqueous solution obtained exhibits a concentration of iSMA No. 1 of approximately 20%.

### Example 6

### Synthesis of a Latex on an iSMA Base (Latex L_{iSMA No. 1})

642 g of the aqueous solution obtained in example 5, comprising 20% of iSMA oligomer No. 1, are introduced into a jacketed glass reactor with a capacity of 1 liter equipped with a central stirrer, a condenser, a temperature probe and a device for continuously introducing an initiator solution and a mixture or a preemulsion of monomers, and the reaction medium is brought to 85° C.

Furthermore, an initiator solution is prepared by dissolution of 3 g of ammonium persulfate in 60 g of demineralized water, and a mixture of monomers is prepared composed of 138 g of styrene and 162 g of butyl acrylate.

When the reaction medium is at 85° C., the initiator solution and the mixture of monomers are fed in over a period of 2 hours, with stirring and while maintaining the temperature at 85° C.

The reaction medium is then kept stirred for an additional two hours at 85° C., then cooled to ambient temperature, filtered through a 100 μm cloth and drained to result in a dispersion of particles (Latex L_{iSMA No. 1}) which exhibits the characteristics reported in table 2.

### Example 7 (Comparative)

### Synthesis of a Latex on an SMA Base (Comparative Latex L_{SMA})

932.64 q of ammoniacal SMA 2000H solution with a content of 19.3% are introduced into a glass reactor with a capacity of 3 liters equipped with a mechanical stirrer, followed by the addition of 267.36 g of demineralized water, and the mixture is brought to 85° C. with stirring. The SMA 2000H copolymer is a copolymer sold by “Atofina” which is a conventional nonimidized SMA neutralized with ammonia in aqueous solution.

Furthermore, an aqueous ammonium persulfate solution is prepared by dissolving 10.8 g of ammonium persulfate in 150 g of demineralized water.

The mixture of monomers, which is composed of 276 g of styrene and of 324 g of butyl acrylate, is also prepared.

When the reaction medium reaches 85° C., the feeding of the initiator solution and of the mixture of monomers is begun in parallel, the introduction taking place over 2 hours.

After the two materials have finished being run in, the reaction medium is maintained for an additional 2 hours at 85° C. Cooling is then carried out to ambient temperature, the reactor is emptied and filtration is carried out through a 100 micrometer cloth.

The latex obtained L_{SMA} exhibits the characteristics shown in table 2 below:

TABLE 2

| Latex | L_{1SMA No. 1} | L_{SMA} |
|---|---|---|
| Solids content (%) | 41 | 39.3 |
| Viscosity, measured using a | 35 | 7800 |
| Brookfield apparatus at 25° C. (mPa · s) | | |
| PH | 4 | 8.3 |
| Average diameter of the particles | 95 | 126 |
| (nm) | | |
| Tg (° C.) | 25 | 25 |

### Example 8 (Invention) and 9 to 13 (Comparative)

### Use of the iSMA Copolymer No. 1 and of Comparative Copolymers as Dispersants

Six pigment pastes having the following composition:

| | | |
|---|---|---|
| Water | 50.0 | g |
| Dispersant | 0.4 | g |
| Acetic acid | 2.5 | g |
| Titanium dioxide | 125 | g |
| Barium sulfate | 125.0 | g |

were prepared while varying, on each occasion, the nature of the dispersant as shown in table 3.

The pigment pastes were prepared with stirring and at acidic pH and their quality was assessed by an evaluation of the viscosity, the desired object being a low viscosity.

The results are reported in table 3.

TABLE 3

| Pigment | | | | | | |
|---|---|---|---|---|---|---|
| paste | 8 | | | | | |
| of | (Inven- | 9⁽¹⁾ | 10⁽²⁾ | 11⁽³⁾ | 12⁽⁴⁾ | 13⁽⁵⁾ |
| example | tion) | (Comp.) | (Comp.) | (Comp.) | (Comp.) | (Comp.) |
| Disper- | Solution | Dow | Surfynol | Noramox | Noramox | Coatex |
| sant | of | Corning | 104 E | C5 | SD 15 | P50 |
| | iSMA | Z6020 | | | | |
| | No. 1 | | | | | |
| Vis- | low | high | high | High | High | high |
| cosity | | | | | | |
| of the | | | | | | |
| paste | | | | | | |

| | |
|---|---|
| (1) Dow Corning Z6020: | Polysiloxane, sold by “Dow |
| | Corning” |
| (2) Surfynol 104 E: | Tetramethyl-5-decyne-4,7-diol, |
| | sold by “Air Products” |
| (3) Noramox C5: | Polyoxyethylene cocoamine, |
| | sold by “Ceca” |
| (4) Noramox SD 15: | Polyoxyethylene tallow amine, |
| | sold by “Ceca” |
| (5) Coatex P50: | Polycarbonate, sold by |
| | “Coatex” |

### Example 14

### Paint Formulation with a Solution of iSMA No. 1 as Dispersant and a Latex L_{iSMA No.} 1 as Binder

A paint composition was prepared formulated as follows:

| Formulation | parts by weight |
|---|---|
| Pigment paste | |
| Water | 84.5 |
| Biocide | 2.0 |
| Solution of 1SMA No. 1 | 1.0 |
| as dispersant | |
| 20% Acetic acid | 2.5 |
| Titanium dioxide | 132.0 |
| Silica 218 | 222.0 |
| Antifoaming agent (Byk 023) | 1.5 |
| Binder | |
| 38.6% Latex_{1SMA} | 500.0 |
| Additives | |
| 2,2,4-Trimethyl-1,3-hydroxypentyl | 11.0 |
| isobutyrate (Texanol) | |
| (coalescing solvent) | |
| Thickener based on associative | 28.0 |
| polyurethane (Rheolate 278) | |
| Water | 14.0 |
| Antifoaming agent (Byk 023) | 1.5 |
| | 1000 |

parts by weight

The constituents of the pigment paste were introduced in the order shown and the mixture was dispersed for 20 minutes at high speed with cooling.

The binder and the additives were successively added, in the order shown, with stirring to the pigment paste thus prepared, and the mixture was kept slowly stirred for 20 minutes.

The paint thus obtained exhibits the following characteristics:

| | |
|---|---|
| PVC: | 40 |
| Solids content by mass: | 55.7 |
| Solids content by volume: | 40.2 |
| Density: | 1.35 |

### Examples 15 to 17 (Invention) and 18 and 19 (Comparative)

### Evaluation of the Blocking of Tannins on Merbau

A first coat of the treatment or of the coating to be tested is applied to a merbau plank. These coatings are shown in table 4 below.

After drying for 4 hours, a coat of standard aqueous paint which has no ability to block tannins is applied as finish.

Depending on the isolating capability of the treatment or of the coating, a more or less pronounced yellowish coloring of the finishing coat may be observed in the minutes which follow. This coloring can be evaluated visually or by colorimetry by measuring the difference in color with respect to the finishing paint applied to a neutral support.

The difference in color DE* (in CIE Lab coordinates) is calculated by the formula:

DE*?\sqrt{DL*² ?Da*² ?Db*²}

with:

L*=the lightness

a*=the redness

b*=the yellowness

Evaluations lead to the results also reported in table 4.

TABLE 4

| | 15 | | | 18 | |
|---|---|---|---|---|---|
| | (Inven- | | 17 | (Comp.) | |
| | tion) | | (Comp.) | Known | 19 |
| | Solution | 16 | Paint of | acrylic | (Comp.) |
| Example | of | (Invention) | example | dispersion* | Known |
| Treatment/ | iSMA | Latex | 14 of the | (nonactive | active |
| Coating | No. 1 | L_{1SMA No. 1} | invention | latex) | latex** |
| Visual | Faintly | Faintly | Faintly | Strongly | Colored |
| appearance | colored | colored | colored | colored | |
| DE* | 2.8 | 2.3 | 2.5 | 5.6 | 4.1 |

*Dispersion sold by “Atofina” under the name “Repolem 2500” and taken here as “nonactive” latex reference, that is to say not exhibiting a specific isolating capability.
**“Active” latex sold by “Röhm & Haas” under the name “Primal MV23”, often chosen for the application of blocking tannins.

### Examples 20 to 22 (Invention) and 23 (Comparative)

### Evaluation of the Resistance of Coatings to Flash Rusting

The coating to be tested as shown in table 5 is applied to untreated steel and the appearance of rust stains at the surface of the film is recorded after drying.

TABLE 5

| Example | 20 | 21 | 22 | 23 |
|---|---|---|---|---|
| Coating | iSMA | Latex | Paint of | Known |
| | solution | L_{iSMA No. 1} | example 14 | acrylic |
| | No. 1 | | of the | dispersion* |
| | | | invention | |
| Flash | Very | Very | Very | Pronounced |
| rusting | slight | slight | slight | |

* Repolem 2500 (cf. comparative example 18)

### Examples 24 (Invention) and 25 (Comparative)

### Evaluation of the Resistance to Water and to Alkaline Hydrolysis

The latex to be tested is applied to a Leneta card for the purpose of obtaining a dry film with a thickness of 3 mm, and drying is allowed to take place for 2 hours before applying, at the surface of the film, for 10 minutes, a drop of demineralized water or a drop of 2% aqueous sodium hydroxide solution.

The deterioration in the film is then recorded qualitatively by assigning a grading ranging from 0 (film destroyed) to 5 (undamaged film).

The evaluations carried out lead to the results reported in table 6 below.

TABLE 6

| Example | 24 (Invention) | 25 (Comparative) |
|---|---|---|
| Latex | L_{1SMA No. 1} | L_{SMA} of example 7 |
| Resistance to | 5 | 5 |
| water | | |
| Alkaline | 5 | 0 |
| resistance | | |

### Example 26

### Applicative Evaluation on a Chalking Face

A. Preparation of the Chalking Face

The chalking face is composed of a mixture of calcium carbonates and of titanium oxide (Durcal 10 and TiO2 RL 68) dispersed in a 2% solution of cellulose thickener based on Natrosol 250 HR, which is applied by spraying over an agglopan board (fiber cement) in increasing thickness.

B. Application of the Primers

The primer, composed of the unformulated latices, is applied with a brush and in excess to the chalking face prepared above, the primer being applied at different dilutions.

The reference primer in a solvent phase, sold by La Seigneurie under the name of Impriderme P, is also applied to the same board, an area of primer-free nonchalking face also being retained as reference.

| | | | | | | |
|---|---|---|---|---|---|---|
| | | | | | | Without |
| Solids | 12% | 6% | 3% | 1.5% | Impriderme | primer |
| content | ? | ? | ? | ? | ? | ? |

| | |
|---|---|
| Thickness of | 20 μm ? |
| the chalking | 50 μm ? |
| face | 100 μm ? |
| | 150 μm ? |

Diagram of the Application to the Board

C. Application of the Finish

After drying for 24 h at 23° C. and 50% RH, a finish based on a gloss paint exhibiting a Pigment Volume Concentration (PVC) of 17% or a matt paint exhibiting a PVC of 81% is applied with a roller and drying is allowed to take place for 8 days at ambient temperature.

D. Adhesion Measurements

The adhesion of each finish to the primer-impregnated face is evaluated. To measure this adhesion, a cross is drawn with a cutter by incising as far as the support, a piece of adhesive tape is adhesively bonded to the cut region and then it is torn off in a swift movement.

The deterioration in the film is evaluated by a grading from 0 (bad) to 10 (excellent), according to the level of residual adhesion of the paint film and to its degree of deterioration.

| | | Without | | Ultrafine |
|---|---|---|---|---|
| Test | L_{1SMA No. 1} | primer | Impriderme | PR 3500 |
| 12% | 5.5 | 1 | 9 | 5.7 |
| 6% | 9 | 1 | 9 | 8.9 |
| 3% | 7.1 | 1 | 9 | 6.4 |

E. Grading* Obtained for the Latices Examined

The grading is the mean value of all 3 of the measurements carried out for each example at a given dilution.

### Example 27

### Applicative Evaluation on Plaster

The substrate is a square of prefabricated plaster with a smooth (slightly glossy) and cohesive (no chalking) surface. The primer is applied with a brush and in excess in one pass, at different dilutions (solids content of 12% to 1.5%).

After drying for 24 h, the system is brought to completion by application of a coat of matt or gloss paint identical to the paints mentioned above and the adhesion is tested in the same way as on a chalking face.

| Dilution/ | | | Without | Ultrafine |
|---|---|---|---|---|
| Product | L_{iSMA No. 1} | Impriderme | primer | PR 3500 |
| 12% | 8.6 | 7.3 | 3 | 7.1 |
| 6% | 8.8 | | | 8.0 |
| 3% | 9.0 | | | 6.2 |
| 1.5% | 8.0 | | | 6.8 |

Grading Obtained for the Latices Examined

* The grading is the mean value of all 3 measurements carried out at a given dilution.

What is claimed is:

1. Composition useful for surface treatment or coating of substrates comprising water, a film forming polymer and/or one or more ethylenically unsaturated monomers, and a surfactant or dispersant consisting essentially of sufficient imidized maleic anhydride polymer to inhibit the migration toward the surface of water-soluble substances present in and/or on the treated or coated or substrate and/or confer water and alkaline hydrolysis resistance to the treated or coated substrate.

2. The composition of claim 1 in the form of an ink or varnish.

3. The composition of claim 1, wherein the imidized maleic anhydride polymer is a cationic polymer prepared by neutralizing an imidized maleic anhydride polymer with an acid.

4. The composition of claim 3, wherein the acid is a volatile weak acid selected from the group consisting of acetic acid and formic acid.

5. The composition of claim 1 further comprising pigment.

6. The composition of claim 1 in the form of a paint or varnish wherein the film forming polymer is the sole binder or as one of the binders.

7. The composition of claim 1 wherein the imidized maleic anhydride polymer is prepared by reaction of a diamine and of a polymer based on maleic anhydride, the diamine having reacted completely with the anhydride functional group in a molar ratio of 1 to 1, said imidized maleic anhydride polymer having a number-average molecular weight of about 500 to 20,000.

8. The composition of claim 1, wherein the imidized maleic anhydride polymer is prepared by reaction of a primary-tertiary diamine and of a polymer based on maleic anhydride, the diamine having reacted completely with the anhydride functional group in a molar ratio of 1 to 1, said imidized maleic anhydride polymer having a number-average molecular weight of about 2,000 to 5,000.

9. The composition of claims 1 wherein the maleic anhydride polymer is a copolymer or terpolymer of maleic anhydride and of hydrophobic monomers chosen from alpha-olefins, unsaturated ethylenic aromatic monomers, vinyl ethers and allyl ethers.

10. The composition of claim 1 wherein the maleic anhydride polymer is a copolymer of styrene and maleic anhydride with a styrene/maleic anhydride molar ratio of 1/1 to 6/1

11. The composition of claim 1 wherein the maleic anhydride polymer is a copolymer of styrene and maleic anhydride with a styrene/maleic anhydride molar ratio of 2/1 to 4/1.

12. The composition of claim 1, wherein the maleic anhydride polymer is a copolymer of styrene and maleic anhydride having an acid number of 500 to 200 KOH/g.

13. The composition of claim 1 wherein the substrate is selected from metal, paper, glass, wood, building materials, such as concrete, leather, and textile.

14. The composition according to claim 1 wherein the monomers are selected from the group consisting of vinyl acetate; styrene; versatic esters; (meth)acrylic acid; acrylamide; and ethylene glycol dimethacrylate, and (meth)acrylic esters, of formula: 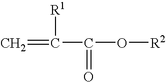
wherein
R¹ represents H or —CH₃;
R² represents a C₁-C₂₂ hydrocarbonaceous group or a —(CH₂)ₙ—C_{n′}F_{2n′} group;
n=1 to 4; and
n=1 to 14.

15. The composition of claim 1 wherein the film foming polymer is in the form of a latex which has a solids content of 20 to 50%.

16. The composition of claim 1 wherein the latex has a particle size of between 50 and 300 nm and an average particle size preferably of less than 100 nm.

17. A primer, varnish, or ink composition for the surface treatment of a substrate comprising an aqueous solution of a polymer based on imidized maleic anhydride polymer, said polymer having been neutralized with an acid in order to exhibit a cationic nature, and a film forming polymer.

18. The primer, varnish, or ink of claim 17 wherein said polymer based on imidized maleic anhydride is prepared by reacting a primary-tertiary diamine with a maleic anhydride polymer.

19. The primer, varnish, or ink of claim 17 further comprising an acrylic, vinylic, or styrene-acrylic film-forming dispersion.

20. Composition comprising a pigment, an acid medium, and sufficient cationic imidized maleic anhydride polymer to disperse the pigment in the acidic medium.

21. The composition of claim 20 in the form of a pigment paste, wherein the cationic imidized maleic anhydride polymer is in an aqueous solution.

22. The pigment paste according to claim 21 comprising, per 100 parts by weight: 20 to 90 parts by weight of pigments; 10 to 80 parts by weight of water; 0.5 to 5 parts by weight of an acid; and 0.05 to 50 parts by weight of the aqueous solution of cationic imidized maleic anhydride.

23. Process of coating or treating a substrate having a water-soluble substance subject to migration toward the surface of the substrate comprising coating or treating the substrate with an aqueous solution or latex composition comprising sufficient imidized maleic anhydride polymer dispersant or emulsifier to inhibit the migration toward the surface of the water-soluble substance.

24. Process of claim 23 wherein the composition is a latex or solution which comprises a film forming polymer and/or one or more ethylenically unsaturated monomers.

25. Process of claim 23 wherein the imidized maleic anhydride polymer is the exclusive surfactant or dispersant in the composition.

26. Process of claim 23 wherein the imidized maleic anhydride is used as the sole surfactant in the preparation of the latex.

27. Process of claim 23 wherein the imidized maleic anhydride polymer is a cationic polymer prepared by neutralizing an imidized maleic anhydride with an acid.

28. Process of treating a substrate comprising applying to the substrate an aqueous solution of a cationic polymer prepared by neutralizing an imidized maleic anhydride with an acid.

29. Process of claim 28 wherein the aqueous solution is applied as a primer.

30. Process of claim 28 wherein the aqueous solution of the cationic polymer is applied in combination with at least one other constituent compatible with said cationic polymer.
